(19) United States
(12) Patent Application Publication
(10) Pub. No.: US 2006/0113912 A1
(43) Pub. Date: Jun. 1, 2006

(54) Plasma display panel

(76) Inventors: Tae-Woo Kim, Suwon-si (KR); Jeong-Nam Kim, Suwon-si (KR); Byoung-Min Chun, Suwon-si (KR); Jeong-Doo Yi, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/280,689

(22) Filed: Nov. 16, 2005

(30) Foreign Application Priority Data
Nov. 30, 2004 (KR) 10-2004-0098977

(51) Int. Cl. H01J 17/49

(52) U.S. Cl. 313/585

(57) ABSTRACT

A plasma display panel device including discharge electrodes with a non-straight edge line, which improves luminous efficiency. The plasma display panel device includes first and second substrates that are disposed to face each other, barrier ribs disposed between the first and second substrates so as to partition a plurality of discharge cells, and phosphor layers that are formed in the discharge cells. The device further includes address electrodes extending in a first direction, first and second electrodes extending in a second direction intersecting the first direction, and third (scan) electrodes, each of which is disposed between and at constant intervals from the first and second electrodes. At least one of the first, second and third electrodes has an edge line extending oblique to the first direction.

### CROSS-REFERENCE TO RELATED APPLICATION

This application claims priority to and the benefit of Korean Patent Application No. 10-2004-0098977 filed in the Korean Intellectual Property Office on Nov. 30, 2004, the entire content of which is incorporated herein by reference.

### BACKGROUND

1. Technical Field

The present invention relates to a display panel, and more particularly, to configurations of electrodes of plasma display panel devices.

2. Discussion of Related Technologies

Generally, a plasma display panel (hereinafter referred to as a ‘PDP’) device displays images using a gas discharge and has superior display ability, including superior display capacity, luminance, contrast, short after-image, and a wide viewing angle.

In a PDP device, a voltage is applied between a sustain electrode and a scan electrode so as to generate a gas discharge between the electrodes. Then, vacuum ultraviolet rays caused by the gas discharge excite phosphors, and the images are realized by visible light generated when the phosphors are stabilized.

The PDP device has front and rear substrates, which are bonded to each other with a barrier rib interposed therebetween. The front substrate has sustain electrodes and scan electrodes. The rear substrate has address electrodes. The barrier rib is formed to divide discharge cells. Each of the discharge cells is filled with an inert gas (for example, a mixed gas of neon (Ne) and xenon (Xe)).

In such a PDP device, if an address voltage is applied to the address electrode and a scan pulse is applied to the scan electrode, an address discharge is generated between the two electrodes and a discharge cell to be turned on is selected. At this time, wall charges are formed. In this state, if sustain pulses having a sustain voltage are applied to the sustain electrode and the scan electrode, a sustain discharge is generated in the selected discharge cell. That is, electrons and ions formed in the sustain electrode and the scan electrode travel between the sustain electrode and the scan electrode. Subsequently, a wall voltage by the wall charges formed at the time of the address discharge and the applied sustain voltage exceed a discharge firing voltage, such that the sustain discharge is generated.

The PDP device has a number of sustain electrodes and scan electrodes for forming the surface discharge structure on the front substrate. Further, in order to generate the sustain discharge with a low sustain voltage, the sustain electrode and the scan electrode are disposed with a short gap therebetween.

In this case, the vacuum ultraviolet rays generated between the sustain electrode and the scan electrode may be distributed in only limited portions of the discharge cell. As a result, only part of the phosphor formed in the discharge cell can be excited, and the PDP device may have low luminous efficiency as a whole.

In order to increase luminous efficiency of the PDP, the sustain electrode and the scan electrode need to be disposed with a large gap and the sustain voltage for the sustain discharge between the sustain electrode and the scan electrode needs to be low.

### SUMMARY OF CERTAIN INVENTIVE ASPECTS

Various aspects of the present invention provide a plasma display panel devices with new configurations of electrodes.

One aspect of the invention provides a plasma display panel, which comprises: first and second substrates disposed to face each other; a plurality of barrier ribs disposed between the first and second substrates so as to partition a plurality of discharge cells; a phosphor layer formed in each of the discharge cells; a plurality of address electrodes formed between the first and second substrates, each address electrode generally extending in a first direction; a plurality of sustain electrodes formed between the first and second substrates, each sustain electrode generally extending in a second direction, and a plurality of scan electrodes disposed between the first and second substrates, each scan electrode generally extending in the second direction.

In the foregoing plasma display panel, the sustain electrodes comprise first and second neighboring sustain electrodes. The first sustain electrode comprises a first sustain edge facing the second sustain electrode. The second sustain electrode comprises a second sustain edge facing the first sustain electrode. At least one of the first and second sustain edges comprises a portion intersecting the first direction obliquely. Further, a first of the scan edges is located between the first and second sustain electrodes. The first scan electrode comprises a first scan edge facing the first sustain electrode and a second scan edge facing the second sustain electrode. At least one of the first and second scan edges comprises a portion intersecting the first direction obliquely.

In the foregoing plasma display panel, at least part of the plurality barrier ribs generally extends in at least one of the first and second directions. At least one of the first and second sustain electrodes comprises a substantially transparent portion and a non-transparent portion. At least part of the discharge cells is substantially rectangularly partitioned by at least part of the barrier ribs, and at least one of the first sustain edge, the second sustain edge and the first scan edge comprises a portion extending in a substantially diagonal direction of one of the rectangular discharge cells. The first scan electrode has a substantially constant distance from the first sustain electrode along the first scan edge. The first scan electrode comprises a substantially transparent portion and a non-transparent portion.

Still in the foregoing plasma display panel, the first scan edge comprises a plurality of linear portions, each of which extends in a direction oblique to the first direction, and the first sustain edge comprises a plurality of portions, each of which extends in a direction oblique to the first direction. The plurality of linear portions of the first scan edge correspond to the plurality of linear portions of the first sustain edge such that a distance between the first scan edge and the first sustain edge substantially the same along the plurality of linear portions thereof. The first pair of sustain electrodes and the first scan electrode are buried in a dielectric layer. The dielectric layer is covered with a protective film. Each of the first and second scan edges comprises a portion extending in a direction oblique to the first direction. Each of the first and second sustain edges comprises a portion extending in a direction oblique to the first direction.

Another aspect of the invention provides a plasma display device, which comprises a plurality of discharge cells forming a matrix; a plurality of address electrodes, each address electrode generally extending along a row of discharge cells arranged in a first axis; a plurality of sustain electrodes, each sustain electrode generally extending along a column of discharge cells arranged in a second axis; a plurality of scan electrodes generally extending in the second axis, each scan electrode being located between a pair of the sustain electrodes. In the device, a first of the scan electrodes is located between a first and a second of the sustain electrodes. The first scan electrode comprises a first scan edge facing the first sustain electrode and a second scan edge facing the second sustain electrode. The first sustain electrode comprises a first sustain edge facing the first scan electrode. The second sustain electrode comprises a second sustain edge facing the first scan electrode. At least one of the first and second sustain edges and the first and second scan edges comprises a portion running along an axis at an acute angle from the second axis.

In the foregoing device, the first scan edge comprises a plurality of linear portions, each of which extends along an axis at an acute angle from the second axis. The first sustain edge comprises a plurality of linear portions, each of which extends along an axis at an acute angle from the second axis. The plurality of linear portions of the first scan edge and the plurality of linear portions of the first sustain edge correspond to each other such that a distance between the first scan edge and the first sustain edge is substantially the same along the plurality of linear portions thereof. The second scan edge comprises a plurality of linear portions, each of which extends along an axis at an acute angle from the second axis. The second sustain edge comprises a plurality of linear portions, each of which extends along an axis at an acute angle from the second axis. The plurality of linear portions of the second scan edge and the plurality of linear portions of the second sustain edge correspond to each other such that a distance between the first scan edge and the first sustain edge remains within 80% of the longest distance along the plurality of linear portions thereof.

Still in the foregoing device, the first scan edge comprises a portion running along an axis at a first acute angle from the second axis, and the second scan edge comprises a portion running along an axis at a second acute angle from the second axis. The first sustain edge comprises a portion running along an axis at a first acute angle from the second axis, and the second sustain edge comprises a portion running along an axis at a second acute angle from the second axis. At least one of the first scan electrode and the first and second sustain electrodes comprises a substantially transparent portion and a non-transparent portion. The non-transparent portion generally extends in the second axis. The portion running in the axis at an acute angle from the second axis is substantially transparent. At least part of the discharge cells are rectangular, and at least one of the first and second sustain edges and the first and second scan edges comprises a portion running in a substantially diagonal direction of one of the rectangular discharge cells. At least one of the first and second sustain edges and the first and second scan edges comprises a non-straight portion. The at least one of the first and second scan edges comprises a zigzag shape.

A further aspect of the invention provides a plasma display device, which comprises first and second sustain electrodes generally extending in a first axis, and a scan electrode generally extending in the first axis and located between the first and second sustain electrodes. The first sustain electrode comprises a first sustain edge facing the second sustain electrode, and the second sustain electrode comprises a second sustain edge facing the first sustain electrode. The scan electrode comprises a first scan edge facing the first sustain electrode and a second scan edge facing the second sustain electrode. At least one of the first and second sustain edges and the first and second scan edges comprises a portion running along an axis at an acute angle from the first axis.

In the foregoing device, at least one of the first and second sustain edges and the first and second scan edges may comprise a zigzag shaped portion. At least one of the first and second sustain edges and the first and second scan edges may comprise a plurality of linear portions, at least part of which extends along an axis at an acute angle from the first axis. At least one of the first and second sustain edges and the first and second scan edges may comprise a non-linear portion.

According to another aspect of the present invention, a plasma display panel includes first and second substrates that are disposed to face each other, a barrier rib that is disposed between the first and second substrates so as to form a plurality of discharge cells, phosphor layers that are formed in the discharge cells, address electrodes that are formed on the first substrate to extend in a first direction, first and second electrodes that are formed on the second substrate to extend in a second direction intersecting the address electrodes and that are disposed on both sides of the respective discharge cells, and third electrodes that are disposed between the first and second electrodes on the second substrate at constant intervals from the first and second electrodes.

The first and second electrodes may have transparent electrodes that are formed to protrude from both sides of the respective discharge cells toward the centers thereof.

The transparent electrodes of each of the first electrodes and the transparent electrodes of each of the second electrodes may form lines for a surface discharge to form discharge gaps in the respective discharge cells, and the lines for a surface discharge may intersect the first direction obliquely.

The barrier rib may have first barrier rib members that are formed to extend in the first direction and second barrier rib members that are formed to extend in the second direction intersecting the first barrier rib members. The barrier ribs may form the discharge cells in a lattice shape.

The first and second electrodes may have bus electrodes that are provided on the transparent electrodes on both sides of the respective discharge cells and that are formed to extend in the second direction.

The lines for a surface discharge of the transparent electrodes may be formed in the respective discharge cells in one diagonal direction thereof.

In this case, the third electrodes may be formed to be bent at constant intervals from the lines for a surface discharge of the first and second electrodes.

The third electrodes may have transparent electrodes that are formed on the second substrate and bus electrodes that are formed on the transparent electrodes.

The lines for a surface discharge of the transparent electrodes may be formed linearly in the respective discharge cells in one diagonal direction thereof.

In this case, the third electrodes may be disposed between the lines for a surface discharge of the transparent electrodes of the first and second electrodes in the respective discharge cells, and may be formed linearly in diagonal directions in parallel with the lines of a surface discharge.

The first, second, and third electrodes may be covered with a dielectric layer. The dielectric layer may be covered with a protective film.

The lines for a surface discharge may be formed longer than the transparent electrodes in the second direction.

Further, the lines for a surface discharge may intersect the second direction obliquely.

### BRIEF DESCRIPTION OF THE DRAWINGS

These and/or other aspects and advantages of the invention will become apparent and more readily appreciated from the following description of the embodiments, taken in conjunction with the accompanying drawings in which:

FIG. 1 is a partially exploded perspective view of a plasma display panel according to an embodiment of the present invention;

FIG. 2 is a plan view of the plasma display panel shown in FIG. 1;

FIG. 3 is a cross-sectional view taken along the line III-III of FIG. 1;

FIG. 4 is a cross-sectional view showing a discharge progress state at the beginning of a sustain discharge; and

FIG. 5 is a cross-sectional view showing a discharge progress state at the time of a full-scale sustain discharge.

### DESCRIPTION OF EMBODIMENTS

Various embodiments of the present invention will now be described in detail with reference to the accompanying drawings, such that the present invention can be made by an ordinarily skilled person in the relevant art. However, the present invention is not limited to the embodiment described below and various changes and modifications can be made. In the drawings, for clear explanation, the descriptions of portions not related to the present invention will be omitted. Moreover, in the overall specification, the same or similar parts are represented by the same reference numerals.

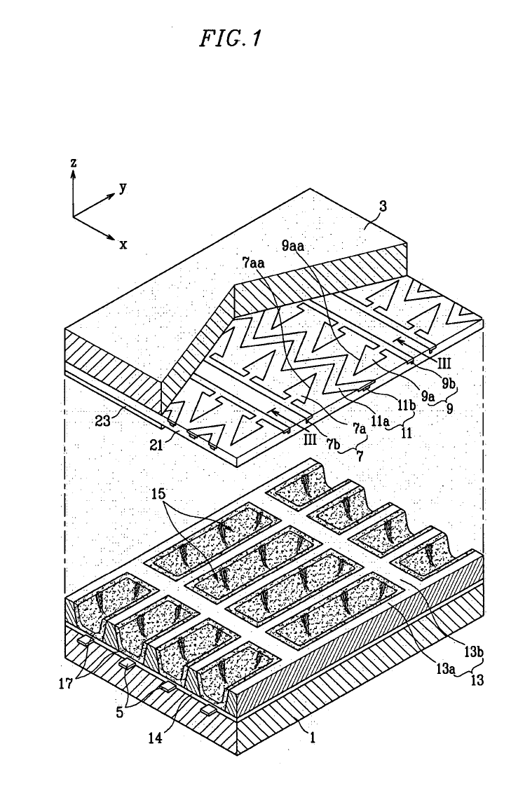

FIG. 1 is a partially exploded perspective view showing a plasma display panel according to an embodiment of the present invention.

Referring to FIG. 1, the PDP according to the present embodiment has a first substrate 1 (hereinafter referred to as “rear substrate”) and a second substrate 3 (hereinafter referred to as “front substrate”), which are disposed to face each other at a predetermined interval and are bonded to each other along peripheries thereof.

Address electrodes 5 are formed on the rear substrate 1 to extend in a first direction (y-axis direction). The address electrodes 5 are disposed at substantially constant intervals in a second direction (x-axis direction). The first direction and the second direction make a right angle.

First electrodes 7 (hereinafter referred to as “first sustain electrodes”), second electrodes 9 (hereinafter referred to as “second sustain electrodes”), and third electrodes 11 (hereinafter referred to as “scan electrodes”) are formed on or over (below in the drawing) the interior surface of the front substrate 3 in the second direction (x-axis direction) to intersect the direction of the address electrodes 5.

The first sustain electrodes 7, the second sustain electrodes 9, and the scan electrodes 11 are disposed at substantially constant intervals in the y-axis direction, respectively.

In the illustrated embodiment, a number of barrier ribs 13 are provided between the front substrate 3 and the rear substrate 1, and partition a plurality of discharge cells 15. In the respective discharge cells 15, in order to generate an address discharge and a sustain discharge, the address electrodes 5, and the first sustain electrodes 7, the second sustain electrodes 9, and the scan electrodes 11, which intersect the direction of the address electrodes 5, are disposed over discharge cells 15.

The barrier rib 13 includes first barrier rib members 13a and second barrier rib members 13b. The first barrier rib members 13a are formed to extend in a direction (y-axis direction) in which the address electrodes 5 extend. The second barrier rib members 13b are formed to extend in a direction (x-axis direction) intersecting the first barrier rib members 13a between adjacent first barrier rib members 13a.

The first barrier rib members 13a are disposed between adjacent address electrodes 5 on the x-y plane. The first barrier rib members 13a extend generally in parallel with the address electrodes 5.

The second barrier rib members 13b extend along with the first sustain electrodes 7 and the second sustain electrodes 9, which are disposed over the respective discharge cells 15 in pairs. The second barrier rib members 13b are formed in a direction intersecting the direction of the address electrodes 5.

The first barrier rib members 13a and the second barrier rib members 13b intersect each other between the rear substrate 1 and the front substrate 3, such that a closed discharge cell is defined.

In the illustrated embodiment, the discharge cells 15 have a rectangular shape in the x-y plane as shown in FIG. 1. In other embodiments, the discharge cells may have different shape in the x-y plane, including a hexagonal shape or in an octagonal shape.

Further in some embodiments, though not shown, the barrier rib 13 may have only the first barrier rib members 13a, without the second barrier rib members 13b. In such a case, the discharge cells will not have partitions between them in the y-axis direction.

Phosphor layers 17 are made of phosphors that are coated on inner surfaces of the barrier rib 13 and a dielectric layer 14 surrounded by the barrier rib 13.

The phosphor compounds of the phosphor layers 17 are excited by vacuum ultraviolet rays created by a plasma discharge, and when the phosphor compounds are stabilized, visible light is generated.

Further, inner spaces of the respective discharge cells 15 are filled with an inert gas (for example, a mixed gas of neon (Ne) and xenon (Xe)). The inert gas generates the vacuum ultraviolet rays during the plasma discharge.

Referring back to FIG. 1, the address electrodes 5 are formed on the rear substrate 1 to extend in the y-axis direction intersecting the direction of the first sustain electrodes 7, the second sustain electrodes 9, and the scan electrodes 11. The address electrodes 5 are covered with the dielectric layer 14.

The dielectric layer 14 protects the address electrodes 5 from damaged during the plasma discharge. Also, the dielectric layer 14 forms and accumulates wall charges during an address discharge.

When an address pulse having an address voltage is applied to the address electrode 5 and a scan pulse is applied to the scan electrode 11, the address discharge is generated in a discharge cell 15 between two electrodes 5 and 11.

Through the address discharge, a discharge cell 15 to be turned on is selected and the wall charges are formed in the selected discharge cell 15.

A set of a first sustain electrode 7, a second sustain electrode 9, and a scan electrode 11 is formed over a row of discharge cells toward the front substrate 3 along the x axis.

During a reset period, a reset discharge is generated by a reset rising waveform and a reset falling waveform applied to the scan electrode 11. During an address period subsequent to the reset period, the address discharge is generated by a scan pulse applied to the scan electrode 11 and an address pulse applied to the address electrode 5. During a sustain period subsequent to the address period, a sustain discharge is generated by sustain pulses that are applied alternately to the first sustain electrode 7 and the second sustain electrode 9.

The first sustain electrodes 7, the second sustain electrodes 9, and the scan electrodes 11 are formed on the front substrate 3 to extend in the x-axis direction. The first sustain electrodes 7, the second sustain electrodes 9, and the scan electrodes 11 are covered with a laminate of a dielectric layer 21 and a protective film 23.

The protective film 23 is made of a transparent material that at least substantially transmits visible light. For example, the protective film 23 may be made of MgO. The protective film 23 protects the dielectric layer 21 from the plasma discharge and increases a secondary electron emission coefficient during the plasma discharge.

In some embodiments, though not shown, the first and second sustain electrodes 7 and 9 may be formed to be shared by adjacent discharge cells 15 in the y-axis direction. In this case, the first and second sustain electrodes 7 and 9 commonly act on the sustain discharge in adjacent discharge cells 15.

Further, when the respective scan electrodes 11 are disposed between the first sustain electrodes 7 and the second sustain electrodes 9, the arrangement of the first sustain electrode 7, the scan electrode 11, the second sustain electrode 9, the scan electrode 11, and the first sustain electrode 7 is repeated over the discharge cells toward the front substrate 3.

In this case, a non-discharge area formed between adjacent discharge cells 15 may be removed, and thus an effective discharge area by each of the discharge cells 15 is increased, thereby enhancing discharge efficiency.

Alternatively, as in the illustrated embodiment, the first sustain electrodes 7 and/or the second sustain electrodes 9 may be dedicated to a row of discharge cells 15 arranged in the x-axis direction rather than shared by another row of discharge cells adjacent in the y-axis direction.

When each scan electrode 11 is disposed between the first sustain electrode 7 and the second sustain electrode 9 dedicated to a single row of discharge cells, the arrangement of the first sustain electrode 7, the scan electrode 11, and the second sustain electrode 9 is repeated over the discharge cells toward the front substrate 3.

The first sustain electrodes 7 and the second sustain electrodes 9 function as the electrodes that apply the sustain pulses required for the sustain discharge, and the scan electrodes 11 function as the electrodes that apply the reset pulses and the scan pulses.

However, the first sustain electrodes 7, the second sustain electrodes 9, and the scan electrodes 11 can perform other functions according to the waveforms of voltage applied thereto. That is, the first sustain electrodes 7, the second sustain electrodes 9, and the scan electrodes 11 are not necessarily limited to the above-described functions.

In some embodiments, though not shown, the first sustain electrodes 7, the second sustain electrodes 9, and the scan electrodes 11 may be made of transparent electrodes 7a, 9a, and 11a, or bus electrodes 7b, 9b, and 11b.

In the illustrated embodiment, the first sustain electrodes 7, the second sustain electrodes 9, and the scan electrodes 11 have transparent portions or electrodes 7a, 9a, and 11a and the bus electrodes 7b, 9b, and 11b.

In this case, the transparent portions or electrodes 7a, 9a, and 11a function for generating the surface discharge in the discharge cells 15 arranged therealong. The transparent portions are made of substantially transparent materials in order to secure a high front aperture ratio of the respective discharge cells 15. In one embodiment, the transparent electrodes 7a, 9a, and 11a can be made of ITO (Indium Tin Oxide).

The bus electrodes 7b, 9b, and 11b are provided often to compensate high electrical resistance of the transparent electrodes 7a, 9a, and 11a and secure sufficient conductivity. In embodiments, the bus electrodes 7b, 9b, and 11b may be made of metals such as aluminum (Al), silver (Ag), or the like.

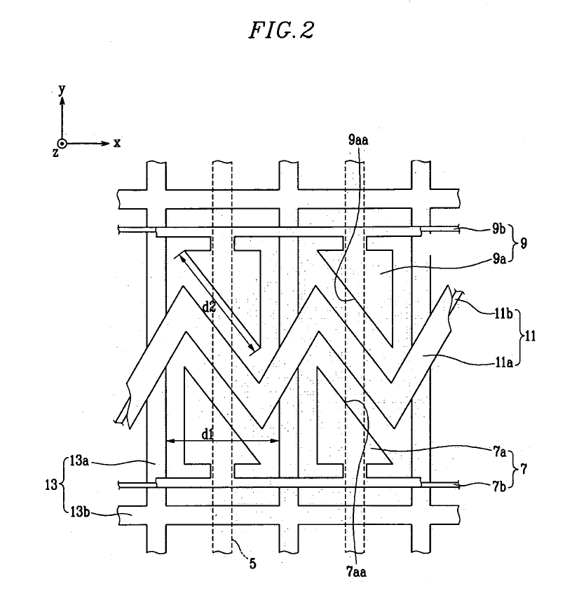

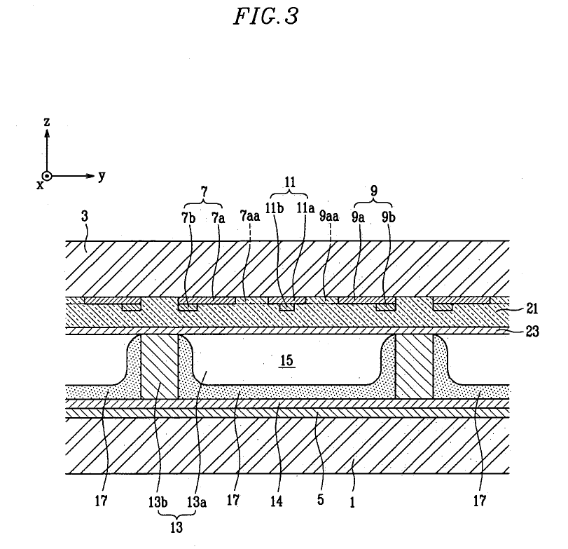

FIG. 2 is a plan view showing the plasma display panel shown in FIG. 1. FIG. 3 is a cross-sectional view taken along the line III-III of FIG. 1.

Referring to FIGS. 2 and 3, the transparent portion or electrodes 7a and 9a of the first and second sustain electrodes 7 and 9 are formed to protrude from both sides of the respective discharge cells 15 toward the centers thereof.

The bus electrodes 7b and 9b of the first and second sustain electrodes 7 and 9 extend generally linearly in the x-axis direction such that a voltage can be applied to the transparent electrodes 7a and 9a. The bus electrodes 7b and 9b are disposed substantially parallel with each other in the y-axis direction.

Further in some embodiments, the bus electrodes 7b and 9b may be formed in meandering shapes (not shown). In other embodiments, the bus electrodes 7b and 9b can be formed in various shapes corresponding to the shape of the barrier rib 13.

The transparent electrodes 7a and 9a form discharge gaps over discharge cells 15 so as to cause the surface discharge to be generated. Further in embodiments, the transparent electrodes 7a and 9a have edge lines 7aa and 9aa for a surface discharge that face each other.

The edge lines 7aa and 9aa for a surface discharge are formed to intersect the y-axis direction obliquely. The edge lines 7aa and 9aa for a surface discharge are also formed to intersect the x-axis direction obliquely.

The edge lines 7aa and 9aa have a length d2 longer than a length d1 in a direction (x-axis direction) perpendicular to the address electrodes 5 in each of the discharge cells 15.

In some embodiments, the edge lines 7aa and 9aa may be formed in a diagonal direction of a rectangular discharge cell 15. In such embodiments, the edge lines 7aa and 9aa may be linear along the diagonal direction. Further in some embodiments, in order to further increase the length d2, the edge lines 7aa and 9aa for a surface discharge may be formed in curved shapes (not shown).

Each of the scan electrodes 11 is disposed between the transparent portion or electrodes 7a and 9a of a paired first and second sustain electrodes 7 and 9. In some embodiments, a scan electrode 11 has one or more edge portions extending oblique to the x-axis or y-axis direction. In some embodiments, a scan electrode 11 has a substantially constant distance from the edge lines 7aa and/or 9aa.

In some embodiments, the edge lines 7aa and 9aa may include one or more linear portions extending in the diagonal direction of a rectangular discharge cell 15. In such embodiments, each of the transparent electrodes 11a and the bus electrodes 11b of the scan electrodes 11 has a portion linearly extending in the diagonal direction of a discharge cell 15 and the portion is also parallel with the edge lines 7aa and 9aa for a surface discharge.

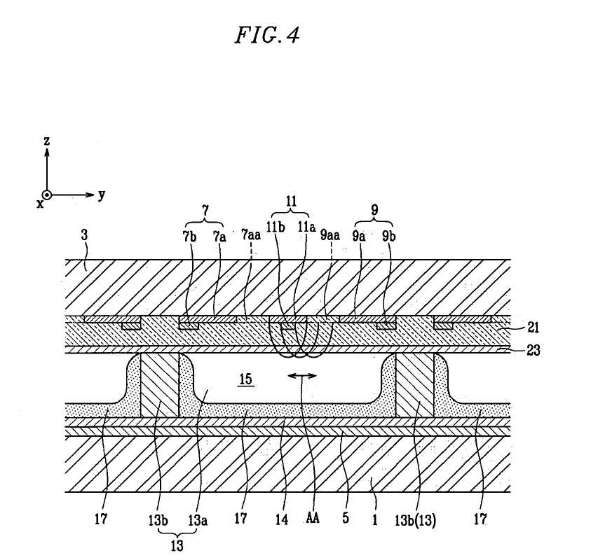

FIG. 4 is a cross-sectional view showing the discharge progress state at the beginning of the sustain discharge.

Referring to FIG. 4, the transparent electrode 11a of each of the scan electrodes 11 faces the transparent electrode edge 9aa of each of the second sustain electrodes 9, which increases the progress AA of the sustain discharge by the length of the edge 9aa for a surface discharge. For this reason, between the scan electrode 11 and the second sustain electrode 9, the length and area of the surface discharge can be increased.

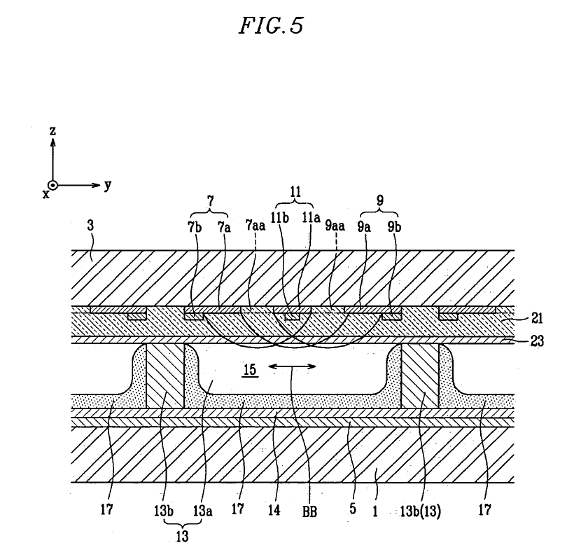

FIG. 5 is a cross-sectional view showing the discharge progress state during full-scale sustain discharge.

Referring to FIG. 5, subsequent to the initial sustain discharge, the full-scale sustain discharge is generated between the first sustain electrode 7 and the second sustain electrode 9. At this time, the edge lines 7aa and 9aa for a surface discharge of the two electrodes 7 and 9 increase the progress BB of the sustain discharge therebetween by the lengths of the edge lines 7aa and 9aa for a surface discharge. For this reason, the length and area of the surface discharge between the first sustain electrode 7 and the second sustain electrode 9 are increased.

With the increase in length and area of the surface discharge, more vacuum ultraviolet rays in the respective discharge cells 15 can be generated. The vacuum ultraviolet rays can reach and excite the phosphor compounds located in an area of the discharge cells 15, which otherwise could not be reached, and thus the amount of visible light can be increased, which results in enhancing luminous efficiency of the PDP.

As described above, in the plasma display panel according to the embodiment of the invention, the transparent electrodes of the first and second sustain electrodes are formed to protrude toward the centers of the respective discharge cells. Further, the edge linesof the transparent electrodes are formed obliquely in the respective discharge cells in the diagonal direction thereof. In addition, the respective scan electrodes are provided between the transparent electrodes at constant intervals from the edge lines. Therefore, the sustain discharge can be realized with a low voltage.

Further, in this PDP, the sustain discharge between the scan electrodes and the second sustain electrodes at the beginning of the sustain discharge progresses in the diagonal direction of the respective discharge cells, and then the full-scale sustain discharge between the first sustain electrodes and the second sustain electrodes progresses in the diagonal direction of the respective discharge cells. Therefore, while the first and second sustain electrodes are disposed with large gaps, the lengths of the edge lines for a surface discharge of the first and second sustain electrodes having a part in the sustain discharge are increased. As a result, luminous efficiency can be enhanced.

Although the present invention has been described in terms of embodiments, it should be understood that various variations and/or modifications of the basic inventive concept taught herein will still fall within the spirit and scope of the present invention, as defined in the appended claims.

What is claimed is:

1. A plasma display panel comprising:
first and second substrates disposed to face each other;
a plurality of barrier ribs disposed between the first and second substrates so as to partition a plurality of discharge cells;
a phosphor layer formed in each of the discharge cells;
a plurality of address electrodes formed between the first and second substrates, each address electrode generally extending in a first direction;
a plurality of sustain electrodes formed between the first and second substrates, each sustain electrode generally extending in a second direction, wherein the sustain electrodes comprise first and second neighboring sustain electrodes, wherein the first sustain electrode comprises a first sustain edge facing the second sustain electrode, wherein the second sustain electrode comprises a second sustain edge facing the first sustain electrode, and wherein at least one of the first and second sustain edges comprises a portion intersecting the first direction obliquely; and
a plurality of scan electrodes disposed between the first and second substrates, each scan electrode generally extending in the second direction, wherein a first of the scan edges is located between the first and second sustain electrodes, wherein the first scan electrode comprises a first scan edge facing the first sustain electrode and a second scan edge facing the second sustain electrode, and wherein at least one of the first and second scan edges comprises a portion intersecting the first direction obliquely.

2. The plasma display panel of claim 1, wherein at least part of the plurality barrier ribs generally extends in at least one of the first and second directions.

3. The plasma display panel of claim 1, wherein at least one of the first and second sustain electrodes comprises a substantially transparent portion and a non-transparent portion.

4. The plasma display panel of claim 1, wherein at least part of the discharge cells is substantially rectangularly partitioned by at least part of the barrier ribs, wherein at least one of the first sustain edge, the second sustain edge and the first scan edge comprises a portion extending in a substantially diagonal direction of one of the rectangular discharge cells.

5. The plasma display panel of claim 1, wherein the first scan electrode has a substantially constant distance from the first sustain electrode along the first scan edge.

6. The plasma display panel of claim 1, wherein the first scan electrode comprises a substantially transparent portion and a non-transparent portion.

7. The plasma display panel of claim 1, wherein the first scan edge comprises a plurality of linear portions, each of which extends in a direction oblique to the first direction, and the first sustain edge comprises a plurality of portions, each of which extends in a direction oblique to the first direction.

8. The plasma display panel of claim 7, wherein the plurality of linear portions of the first scan edge correspond to the plurality of linear portions of the first sustain edge such that a distance between the first scan edge and the first sustain edge is substantially the same along the plurality of linear portions thereof.

9. The plasma display panel of claim 1, wherein the first pair of sustain electrodes and the first scan electrode are buried in a dielectric layer.

10. The plasma display panel of claim 9, wherein the dielectric layer is covered with a protective film.

11. The plasma display panel of claim 1, wherein each of the first and second scan edges comprises a portion extending in a direction oblique to the first direction.

12. The plasma display panel of claim 1, wherein each of the first and second sustain edges comprises a portion extending in a direction oblique to the first direction.

13. A plasma display device comprising:
a plurality of discharge cells forming a matrix;
a plurality of address electrodes, each address electrode generally extending along a row of discharge cells arranged in a first axis;
a plurality of sustain electrodes, each sustain electrode generally extending along a column of discharge cells arranged in a second axis;
a plurality of scan electrodes generally extending in the second axis, each scan electrode being located between a pair of the sustain electrodes; and
wherein a first of the scan electrodes is located between a first and a second of the sustain electrodes, wherein the first scan electrode comprises a first scan edge facing the first sustain electrode and a second scan edge facing the second sustain electrode, wherein the first sustain electrode comprises a first sustain edge facing the first scan electrode, wherein the second sustain electrode comprises a second sustain edge facing the first scan electrode, wherein at least one of the first and second sustain edges and the first and second scan edges comprises a portion running along an axis at an acute angle from the second axis.

14. The plasma display device of claim 13, wherein the first scan edge comprises a plurality of linear portions, at least part of which extends along an axis at an acute angle from the second axis.

15. The plasma display device of claim 14, wherein the first sustain edge comprises a plurality of linear portions, at least part of which extends along an axis at an acute angle from the second axis.

16. The plasma display device of claim 15, wherein the plurality of linear portions of the first scan edge and the plurality of linear portions of the first sustain edge correspond to each other such that a distance between the first scan edge and the first sustain edge is substantially the same along the plurality of linear portions thereof.

17. The plasma display device of claim 13, wherein the second scan edge comprises a plurality of linear portions, at least part of which extends along an axis at an acute angle from the second axis.

18. The plasma display device of claim 17, wherein the second sustain edge comprises a plurality of linear portions, at least part of which extends along an axis at an acute angle from the second axis.

19. The plasma display device of claim 18, wherein the plurality of linear portions of the second scan edge and the plurality of linear portions of the second sustain edge correspond to each other such that a distance between the first scan edge and the first sustain edge remains within 80% of the longest distance along the plurality of linear portions thereof.

20. The plasma display device of claim 13, wherein the first scan edge comprises a portion running along an axis at a first acute angle from the second axis, and wherein the second scan edge comprises a portion running along an axis at a second acute angle from the second axis.

21. The plasma display device of claim 13, wherein the first sustain edge comprises a portion running along an axis at a first acute angle from the second axis, and wherein the second sustain edge comprises a portion running along an axis at a second acute angle from the second axis.

22. The plasma display device of claim 13, wherein at least one of the first scan electrode and the first and second sustain electrodes comprises a substantially transparent portion and a non-transparent portion.

23. The plasma display device of claim 22, wherein the non-transparent portion generally extends in the second axis.

24. The plasma display device of claim 22, wherein the portion running in the axis at an acute angle from the second axis is substantially transparent.

25. The plasma display device of claim 13, wherein at least part of the discharge cells are rectangular, and wherein at least one of the first and second sustain edges and the first and second scan edges comprises a portion running in a substantially diagonal direction of one of the rectangular discharge cells.

25. The plasma display device of claim 13, wherein at least one of the first and second sustain edges and the first and second scan edges comprises a non-straight portion.

26. The plasma display device of claim 13, wherein the at least one of the first and second scan edges comprises a zigzag shape.

27. A plasma display device comprising:
first and second sustain electrodes generally extending in a first axis, the first sustain electrode comprising a first sustain edge facing the second sustain electrode, the second sustain electrode comprising a second sustain edge facing the first sustain electrode;
a scan electrode generally extending in the first axis and located between the first and second sustain electrodes, the scan electrode comprising a first scan edge facing the first sustain electrode and a second scan edge facing the second sustain electrode; and
wherein at least one of the first and second sustain edges and the first and second scan edges comprises a portion running along an axis at an acute angle from the first axis.

26. The plasma display device of claim 25, wherein at least one of the first and second sustain edges and the first and second scan edges comprises a zigzag shaped portion.

27. The plasma display device of claim 25, wherein at least one of the first and second sustain edges and the first and second scan edges comprises a plurality of linear portions, at least part of which extends along an axis at an acute angle from the first axis.

28. The plasma display device of claim 13, wherein at least one of the first and second sustain edges and the first and second scan edges comprises a non-linear portion.
